(19) United States
(12) Patent Application Publication
(10) Pub. No.: US 2011/0036310 A1
(43) Pub. Date: Feb. 17, 2011

(54) HYDROGEN SUPPLY UNIT FOR INTERNAL COMBUSTION ENGINE AND METHOD OF OPERATING INTERNAL COMBUSTION ENGINE

(75) Inventors: Masaru Ichikawa, Tokyo (JP); Akira Koikeda, Hokkaido (JP); Kunio Komori, Aichi (JP); Satoru Kikuchi, Ibaraki (JP); Takeshiro Ito, Aichi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: Masaru Ichikawa, Tokyo (JP); HREIN ENERGY, INC., Sapporo-shi, Hokkaido (JP); FUTABA INDUSTRIAL CO., LTD., Okazaki-shi, Aichi (JP); ALUMI SURFACE TECHNOLOGIES CO., LTD., Toride-shi, Ibaraki (JP); ITO RACING SERVICE CO., LTD., Okazaki-shi, Aichi (JP)

(21) Appl. No.: 12/867,678

(22) PCT Filed: Jul. 4, 2008
(86) PCT No.: PCT/JP2008/062196

§ 371 Date: Oct. 13, 2010

(30) Foreign Application Priority Data
Feb. 13, 2008 (JP) 2008-032353

(51) Int. Cl. F02B 43/08

(52) U.S. Cl. 123/3

(57) ABSTRACT

An efficient internal combustion engine jointly using hydrogen obtained by dehydrogenation of a hydrogen supply mass. There is disclosed a hydrogen supply unit for internal combustion engine comprising hydrogen separating means, storage means for storage of separated hydrogen, means for storage of dehydrogenation products and means for addition supply of produced hydrogen to a fuel source. The hydrogen separating means for separating produced hydrogen from dehydrogenation products, includes a dehydrogenation reactor for production of hydrogen from a hydrogen supply mass using at least either the hydrogen supply mass or a hydrocarbon fuel as the fuel source, which dehydrogenation reactor on its one face is provided with a hydrogen production section bearing a dehydrogenation catalyst and on its other face is provided with an oxidation reaction section allowing passage of an exhaust from the internal combustion engine and bearing an oxidation catalyst for oxidizing any dehydrogenation products from the hydrogen supply mass to thereby bring about heat generation.

### TECHNICAL FIELD

This invention relates to a hydrogen supply unit for supplying hydrogen by way of a dehydrogenation reaction of a liquid hydrogen supply mass, utilizing waste heat of the exhaust system of an internal combustion engine, and a method of operating such an internal combustion engine by using the hydrogen produced by the same.

### BACKGROUND ART

The inventors of the present invention have proposed that hydrogen can easily be separated from and recombined with liquid organic compounds obtained by hydrotreating unsaturated compounds such as aromatic compounds and such compounds can be used as liquid hydrogen supply mass. Such a hydrogen supply mass of organic compounds is also referred to as organic hydride.

There have been proposed internal combustion engines utilizing hydrogen and the dehydrogenation product obtained by way of a dehydrogenation reaction of the hydrotreated fuel such as organic hydride that is loaded in an automobile as fuel, wherein at least the hydrotreated fuel, the dehydrogenation product or hydrogen is arbitrarily selected as fuel for the internal combustion engine (see, for example, Patent Literature 1).

However, a dehydrogenation reaction catalyst is carried by a honeycomb carrier and there has been a problem that, while the thermal energy of exhaust is thermally transferred by way of an exhaust pipe of the honeycomb carrier that is formed to surround the exhaust pipe of an internal combustion engine, the thermal transfer rate is low and, when the automobile is accelerated, the hydrogen generating rate cannot satisfactorily follow the acceleration.

### Patent Document 1: JP-A-2005-147124

### DISCLOSURE OF THE INVENTION

### Problem to be Solved by the Invention

Therefore, a problem to be solved by the invention is to provide an internal combustion engine to be supplied with the hydrogen produced from organic hydride that is a hydrogen supply mass by way of a dehydrogenation reaction along with hydrocarbon-based fuel to improve the combustion efficiency of hydrocarbons and make it possible to operate at a high air-fuel ratio, reduce the emission of carbon dioxide and improve the consumption of hydrocarbons. Another problem to be solved by the invention is to provide an internal combustion engine having a hydrogen supply unit wherein the hydrogen production from a hydrogen supply mass by way of a dehydrogenation reaction is highly responsive to fluctuations of the load of the internal combustion engine.

### Means for Solving the Problem

According to the present invention, there is provided a hydrogen supply unit for an internal combustion engine using at least either a hydrogen supply mass or hydrocarbon-based fuel as fuel source and including a dehydrogenation reactor that produces hydrogen from a hydrogen supply mass, the dehydrogenation reactor having on a surface thereof a hydrogen production section carrying a dehydrogenation catalyst and on the other surface thereof an oxidation reaction section carrying an oxidation catalyst for oxidizing the dehydrogenation product produced from the hydrogen supply mass to emit heat, the oxidation reaction section allowing the exhaust from the internal combustion engine to pass therethrough, a hydrogen separating means for separating the produced hydrogen and the dehydrogenation product, a storage means for storing the separated hydrogen, a means for storing the dehydrogenation product and a means for supplying and adding the produced hydrogen to the fuel source.

Preferably, in the hydrogen supply unit for an internal combustion engine, the dehydrogenation catalyst and the oxidation catalyst of the dehydrogenation reactor are borne on the surfaces of porous alumina layers formed after turning the aluminum layers laid on a metal base member into alumite.

Preferably, the hydrogen supply unit for an internal combustion engine further includes an electrically energizing/heating means for heating the dehydrogenation catalyst by electrically energizing and heating the metal base member itself.

Preferably, in the hydrogen supply unit for an internal combustion engine, the dehydrogenation reactor is provided with a dehydrogenation product supply nozzle and an air feed pipe for heating a hydrogen reaction section along with a temperature sensor and a hydrogen supply mass injection nozzle.

Preferably, in the hydrogen supply unit for an internal combustion engine, an exhaust pipe connected to the dehydrogenation reactor is provided with a branch section that branches the exhaust pipe and the branch section is provided with an exhaust flow rate regulation valve that regulates the flow rate of exhaust according to the temperature of a hydrogen production means.

Preferably, the hydrogen supply unit for an internal combustion engine further includes a hydrogen supply means for supplying the produced hydrogen to an exhaust purification catalyst converter.

In another aspect of the invention, there is provided a method of operating an internal combustion engine using at least either a hydrogen supply mass or hydrocarbon-based fuel as fuel source and including a dehydrogenation reactor that produces hydrogen from a hydrogen supply mass, the dehydrogenation reactor having on a surface thereof a hydrogen production section carrying a dehydrogenation catalyst and on the other surface thereof an oxidation reaction section carrying an oxidation catalyst for oxidizing the dehydrogenation product produced from the hydrogen supply mass to emit heat, the oxidation reaction section allowing the exhaust from the internal combustion engine to pass therethrough, a hydrogen separating means for separating the produced hydrogen and the dehydrogenation product, a storage means for storing the separated hydrogen, a means for storing the dehydrogenation product and a means for supplying and adding the produced hydrogen to the fuel source, the method including measuring the concentration of the carbon dioxide discharged from an exhaust pipe of the internal combustion engine and controlling the mixing ratio of hydrogen relative to hydrocarbon fuel so as to make the measured value of the concentration of carbon dioxide not greater than a predetermined value.

In the method of operating an internal combustion engine, the dehydrogenation catalyst is heated by electrically energizing and heating a member of the dehydrogenation reactor.

In the method of operating an internal combustion engine, a dehydrogenation reaction is realized by combusting the dehydrogenation product from a dehydrogenation product supply nozzle with air supplied from an air feed pipe to heat a hydrogen reaction section of the dehydrogenation reactor to a predetermined temperature when the temperature of the hydrogen reaction section is lower than the predetermined value, and subsequently injecting a hydrogen supply mass from a hydrogen supply mass injection nozzle.

In the method of operating an internal combustion engine, the concentration of discharged nitrogen oxide is regulated by supplying part of the hydrogen produced from the hydrogen supply mass to an exhaust purification catalyst converter.

### ADVANTAGE OF THE INVENTION

According to the present invention, a dehydrogenation reaction of a hydrogen supply mass is realized by means of a dehydrogenation reactor having a catalyst reaction layer formed on a surface thereof and an oxidation catalyst layer formed on the other surface thereof, utilizing the waste heat of the exhaust system of an internal combustion engine. Therefore, the waste heat of the exhaust system can efficiently be utilized to make it possible to efficiently produce hydrogen. Additionally, when the produced hydrogen is used with fuel for the internal combustion engine, it can be combusted stably at a high air-fuel ratio so as to make it possible to improve the fuel consumption and suppress the production of carbon dioxide. Additionally, the concentration of nitrogen oxide that is increasingly produced in a state where the air-fuel ratio is high can be reduced when hydrogen is supplied to the exhaust catalyst converter.

### BRIEF DESCRIPTION OF THE DRAWINGS

FIG. 1 is a schematic illustration of the overall configuration of an internal combustion engine including a hydrogen supply unit according to the present invention.

FIG. 2 is a schematic illustration of the operation of a hydrogen supply unit for an internal combustion engine according to the present invention.

FIG. 3 is a schematic illustration of an embodiment of dehydrogenation reactor.

### EXPLANATION OF REFERENCE SYMBOLS

1: internal combustion engine
3: air purifier
5: air flow meter
7: fuel tank
9: feed pump
11: gasoline injector
13: ignition plug
15: exhaust pipe
17: exhaust purification catalyst converter
19: dehydrogenation reactor
21: hydrogen supply mass storage tank
23: supply pump
24: hydrogen supply mass injector
25: mixture discharge pipe
26: hydrogen separation unit
27: compression pump
29: hydrogen storage tank
31: dehydrogenation product storage tank
33: exhaust pipe
35: air supply means
37: dehydrogenation product supply pipe
38: feed pump
39: muffler
40: injector
41: flow rate regulation valve
43: bypass conduit
45, 45A: hydrogen injector
47: control unit
61: cabinet
62: reaction pipe
63: dehydrogenation reaction section
65: oxidation reaction section
67: metal base member
69: aluminum layer
71: dehydrogenation catalyst
73: oxidation catalyst

### BEST MODE FOR CARRYING OUT THE INVENTION

According to the present invention, an internal combustion engine is made to have a hydrogen production reactor for a dehydrogenation reaction that utilizes the waste heat of the exhaust of the internal combustion engine operating as means for heating the hydrogen production reactor when using a hydrogen supply mass such as methylcyclohexane that can be easily dehydrogenated as hydrogen source. Additionally, it has been found that, when the hydrogen production reactor has on a surface thereof a hydrogen production reaction section carrying a dehydrogenation reaction catalyst and on the other surface thereof an oxidation reaction section carrying an oxidation catalyst for oxidizing the dehydrogenation product produced from the hydrogen supply mass to emit heat, the hydrogen supply unit for an internal combustion engine can be held to a predetermined temperature even when it is heated insufficiently by the exhaust heat of the internal combustion engine and hence can stably supply hydrogen.

Now, the present invention will be described in greater detail by referring to the drawings.

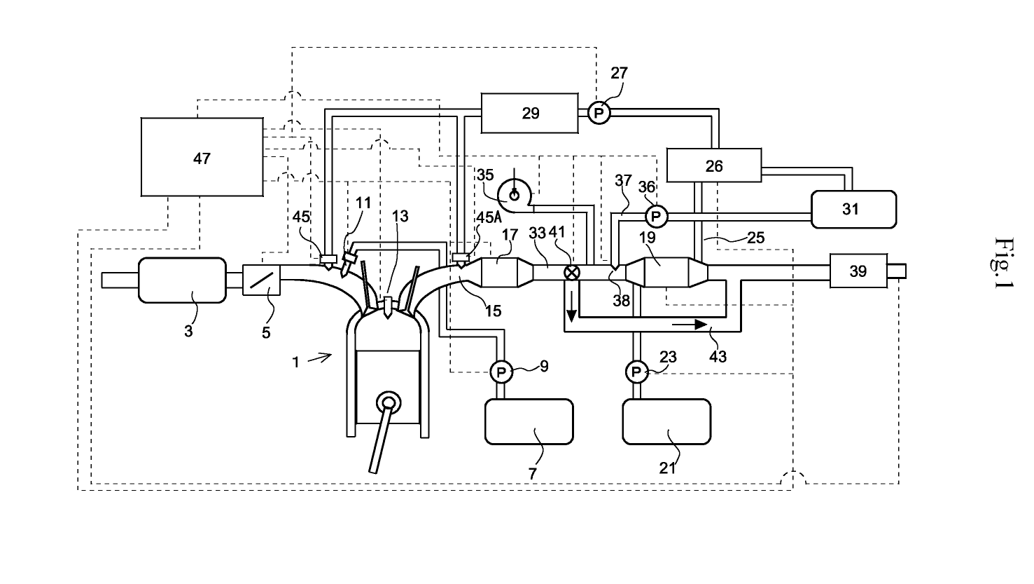

FIG. 1 is a schematic illustration of the overall configuration of an internal combustion engine including a hydrogen supply unit according to the present invention.

The internal combustion engine 1 is supplied with air that is purified by an air purifier 3 by way of an air flow meter 5. At the same time, hydrocarbons such as gasoline stored in a fuel tank 7 are supplied and injected from a gasoline injector 11 by means of a supply pump 9 into the cylinder of the engine and ignited by an ignition plug 13 to operate the internal combustion engine.

The exhaust that is produced by combustion is fed to an exhaust purification catalyst converter 17 by means of an exhaust pipe 15 and purified there before the exhaust is supplied to a dehydrogenation reactor 19.

A hydrogen supply mass such as methylcyclohexane is supplied to the dehydrogenation reactor 19 from a hydrogen supply mass storage tank 21 and injected into the reactor 19 by a hydrogen supply mass injector 24 so that a dehydrogenation reaction takes place by the catalyst arranged in the dehydrogenation reaction section of the dehydrogenation reactor 19. The mixture of hydrogen and the dehydrogenation product is fed to a hydrogen separation unit 26 by way of a mixture discharge pipe 25 and hydrogen is separated from the dehydrogenation product there. The separated hydrogen is compressed by a compression pump 27 and then stored in a hydrogen storage tank 29. The dehydrogenation product including toluene is stored in a hydrogen storage mass storage tank 31 so as to be reused as hydrogen storage mass.

Compounds that can be used for a hydrogen supply mass include those that are produced by adding hydrogen to hydrocarbons and their derivatives having one or more than one unsaturated bonds of aromatic hydrocarbons and their derivatives selected from cyclohexane, methylcyclohexane, dimethylcyclohexane, tetralin, decalin, methyldecalin and so on and can relatively easily cause a dehydrogenation reaction to take place and produce hydrogen.

An air supply means 35 and a dehydrogenation product supply pipe 37 are connected to an exhaust pipe 33 for supplying exhaust to the dehydrogenation reactor 19. When the dehydrogenation catalyst temperature of the dehydrogenation reactor 19 is lower than the dehydrogenation reaction temperature, the dehydrogenation product supplied from the dehydrogenation product supply pipe 37 is burnt with the air supplied from the air supply means 35 in the dehydrogenation reactor 19 under the effect of the oxidation catalyst. As a result, the dehydrogenation catalyst is heated to the predetermined reaction temperature. Additionally, the exhaust that passes through the dehydrogenation reactor 19 is discharged to the outside from a muffler 39.

On the other hand, the exhaust pipe 33 has a flow rate regulation valve 41 and a bypass conduit 43 that bypass the dehydrogenation reactor 19 so that, when hot exhaust flows into the dehydrogenation reactor 19 from the exhaust pipe to raise the temperature of the dehydrogenation reactor 19 above a predetermined level, the temperature of the dehydrogenation reactor 19 can be lowered to the predetermined level by feeding exhaust to the bypass conduit.

The hydrogen stored in a hydrogen storage tank 29 is supplied to the suction system from a hydrogen injector 45 so as to serve as fuel for the internal combustion engine.

As the hydrogen stored in the hydrogen tank 29 is supplied to the exhaust catalyst converter 17 by a hydrogen injector 45A, the hydrogen can reduce the concentration of the nitrogen oxide that is increasingly produced in a lean-burn state.

The above described gasoline injector, the hydrogen injector, the pump, the flow meter, the flow rate regulation valve, the temperature sensor, the ignition plug and so on are connected to a control unit 47, which controls the quantity of injected hydrogen, the injection interval, the flow rate, the required quantity of hydrogen and so on according to the driving conditions such as the load of the internal combustion engine, the degree of the accelerator opening, the degree of acceleration and so on.

While hydrogen is mixed with air in the suction system at the outside of the cylinder in the above description, hydrogen may alternatively be supplied directly into the cylinder from the hydrogen storage tank where hydrogen is stored under pressure.

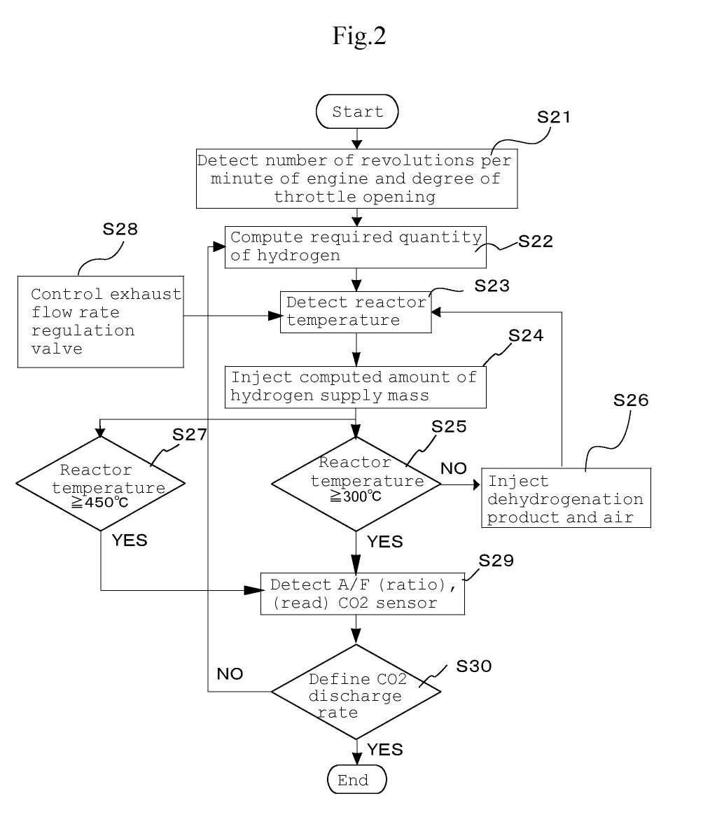

FIG. 2 is a schematic illustration of the operation of a hydrogen supply unit for an internal combustion engine according to the present invention.

When starting the internal combustion engine 1, the operating conditions are detected in Step S21 and the required quantity of hydrogen is computed in Step S22. Then, in Step S23, the dehydrogenation catalyst temperature of the dehydrogenation reaction section of the dehydrogenation reactor 19 is detected and the quantity of hydrogen supply mass to be injected is computed in Step S24. Thus, a hydrogen supply mass is injected by the computed quantity.

At this time, if it is determined in Step S25 that the temperature of the dehydrogenation catalyst of the dehydrogenation reactor is not higher than 300 degrees C., the temperature is raised by driving the supply pump 38 to operate for supplying the hydrogen storage mass, which is a dehydrogenation product, stored in the hydrogen storage mass storage tank 31 in order to raise the dehydrogenation catalyst temperature by way of the hydrogen storage mass supply pipe 37, the injector 40 and the air supply means 35 for burning the hydrogen storage mass.

According to the present invention, the dehydrogenation reactor may be equipped with an electric heater for electric energization and heating or, alternatively, the metal base member of the dehydrogenation reception section of the dehydrogenation reactor may be directly electrically energized and heated.

When, on the other hand, it is determined in Step S27 that the temperature of the dehydrogenation reactor is not lower than 450° C., the exhaust flow rate regulation valve 41 is driven to operate and part of the exhaust is fed to the muffler 39 by way of the exhaust bypass conduit 43 and the temperature of the dehydrogenation reactor is controlled so as to be between 300° degrees C. and 450 degrees C.

Then, in Step S29, the entire system is so controlled as to make it discharge carbon dioxide by at the rate defined in Step S30 according to the air-fuel ratio and the signal detected in Step S29 by the carbon dioxide sensor arranged at the exhaust pipe opening.

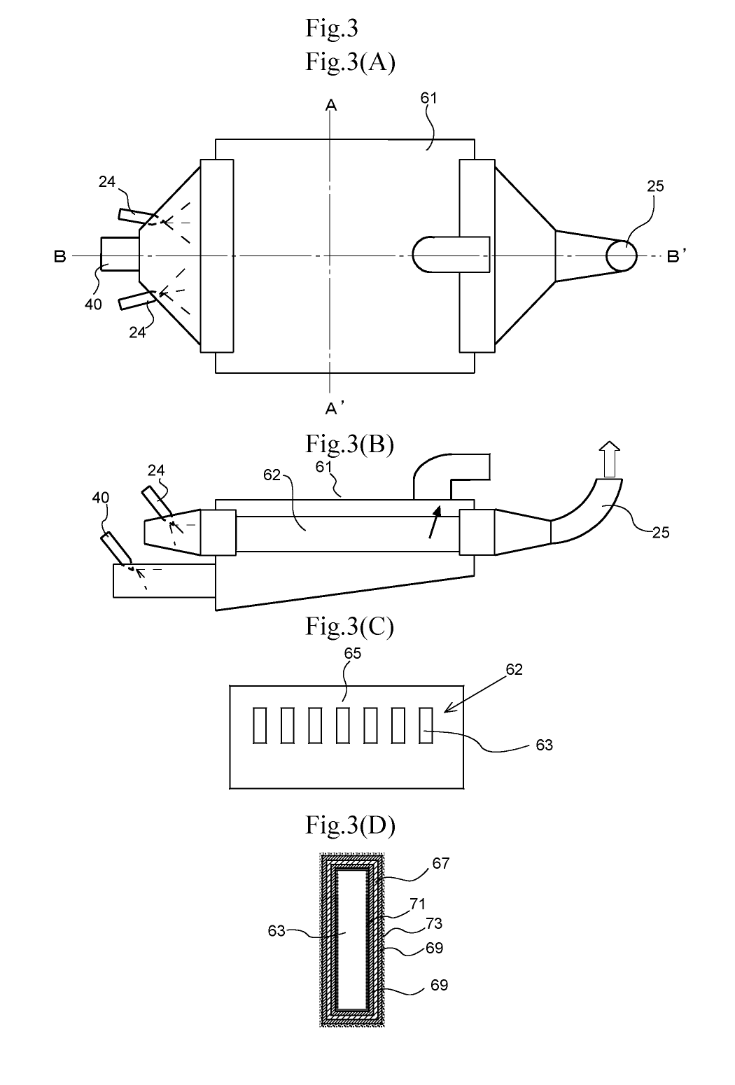

FIG. 3 is a schematic illustration of an embodiment of dehydrogenation reactor.

FIG. 3(A) is a plan view, FIG. 3(B) is a cross sectional view taken along line A-A′ in FIG. 3(A), FIG. 3(C) is a cross sectional view taken along line B-B′ in FIG. 3(A) and FIG. 3(D) is an enlarged view of one of the reaction pipes shown in FIG. 3(C).

The dehydrogenation reactor 19 has in the inside thereof at least a reaction pipe 62 in a cabinet 61 made of a heat-resistant metal material such as stainless steel. The reaction pipe 62 has a dehydrogenation reception section 63 and an oxidation reception section 65 respectively formed at opposite surfaces thereof.

The reaction pipe 62 is prepared by forming aluminum layers 69 on the opposite surfaces of a metal base member 67 of stainless steel, a nickel alloy or the like by means of a technique selected from cladding, electroless plating and so on. The surfaces of the aluminum layers are subjected to an alumite process and subsequently to a hydrothermal treatment or the like to produce porous alumina layers thereon. The porous alumina layers respectively carry thereof a dehydrogenation catalyst 71 and an oxidation catalyst 73.

The dehydrogenation catalyst and the oxidation catalyst can be prepared by applying a solution of a compound containing at least an element selected from platinum, palladium, rhodium, rhenium and ruthenium and subsequently baking it.

Exhaust is made to pass through the outer space of the reactor pipe 62 to heat the dehydrogenation catalyst to a predetermined temperature and subsequently the exhaust is discharged. A hydrogen supply mass such as methylcyclohexane is injected into the internal space of the reactor pipe 62 by means of a hydrogen supply mass injector 24 to produce hydrogen and a dehydrogenation product such as toluene, which are then taken out by way of the mixture discharge pipe 25.

An oxidation reaction section 65 is formed on one of the outer surfaces of the reactor pipe 62 and carries an oxidation catalyst 73. Therefore, when the supplied exhaust cannot raise the temperature of the dehydrogenation catalyst to the reaction temperature, the dehydrogenation catalyst can be heated to the predetermined temperature by injecting the dehydrogenation product that is a hydrogen storage mass from the injector 40 and, at the same time, supplying air from the discharge pipe by an air supply means (not shown) to exploit the effect of the oxidation catalyst 73.

The catalyst layers are formed in the dehydrogenation reactor of the present invention by laying aluminum, which is a good thermal conductor, on the surfaces of a heat-resistant metal material. Therefore, they conduct heat well so that the waste heat that the exhaust has can be effectively utilized.

An electrically energizing means may be connected to the heat-resistant metal material and the metal material may be electrically energized from a power source such as the battery loaded in the automobile to heat the heat-resistant metal material in order to heat the dehydrogenation catalyst to a predetermined temperature.

While the dehydrogenation reactor shown in FIG. 3 has a pipe-shaped reactor as an example, a continuous corrugated plate carrying respectively a dehydrogenation catalyst layer and an oxidation catalyst layer on the opposite surfaces thereof may alternatively be employed.

In an internal combustion engine according to the present invention, the exhaust can contain nitrogen oxides to a higher extent when hydrogen is mixed with hydrocarbon-based fuel if compared with an instance where hydrogen is not mixed with fuel, although the hydrocarbon content of the exhaust falls. If such is the case, the concentration of the discharged nitrogen oxides can be reduced by injecting part of the hydrogen to be compounded with the fuel of the internal combustion engine into the exhaust purification catalyst converter 17 by means of the hydrogen injector 45A.

### EXAMPLES

Now, the present invention will be described further by way of examples and comparative examples.

### Example 1 and Comparative Example 1

A hydrogen production unit having a fin-shaped platinum bearing alumite catalyst carrying pipe-shaped reactor as shown in FIG. 3 is mounted in an automobile having a 1 L engine. The temperature of the catalyst is held to 300 degrees C.-350 degrees C. by heating the catalyst by means of engine exhaust and methylcyclohexane is injected onto the catalyst as organic hydride to produce hydrogen.

The produced hydrogen is introduced into the engine at a supply rate of 10-50 L/min from a hydrogen injector. The discharged carbon dioxide concentration and the fuel consumption rate were observed at the chassis dynamo for both a gasoline-hydrogen mixture combustion system where hydrogen is added to gasoline and a conventional gasoline combustion system using only gasoline. Table 1 shows the obtained results along with the number of revolutions per minute (rpm) of the engine and the air-fuel ratio.

In Table 1, tests 1-1 through 1-4 show examples and comparison tests 1-1 and 1-2 show comparative examples.

In the case of the internal combustion engine where a gasoline-hydrogen mixture prepared by adding hydrogen by 3-6% to gasoline was combusted, a stable engine combustion-operation was realized with a high air-fuel ratio (in a lean-burn condition) and the discharged carbon dioxide concentration was reduced by 22-34% relative to the instance where only gasoline was combusted. Additionally, a hydrogen addition effect of improving the fuel consumption rate by 26-66% was obtained.

Note that the engine was driven to operate under the condition where the gasoline supply rate was 3.1 L/h in the tests 1-1, 1-2, 1-4 and 1-5,

the gasoline supply rate was 4.2 L/h in the test 1-3 and

the gasoline supply rate was 6.1 L/h in the comparative tests 1-1 and 1-2. The engine was driven to operate with a degree of accelerator opening of 30% for all the tests.

TABLE 1

| | | | | | | | Comp. | Comp. |
|---|---|---|---|---|---|---|---|---|
| | | Test | Test | Test | Test | Test | test | test |
| | | 1-1 | 1-2 | 1-3 | 1-4 | 1-5 | 1-1 | 1-2 |
| added hydrogen | | 2.0 | 2.0 | 1.5 | 4.5 | 4.5 | 0 | 0 |
| volume % | | | | | | | | |
| air-fuel ratio | | 22.7 | 22.7 | 19.0 | 22.2 | 21.8 | 14.5 | 14.4 |
| volume ratio | | | | | | | | |
| number of | | 2500 | 4000 | 4000 | 2500 | 4000 | 2500 | 4000 |
| revolutions per | | | | | | | | |
| minute (rpm) | | | | | | | | |
| carbon | concen- | 9.3 | 10.0 | 10.2 | 8.7 | 8.9 | 13.1 | 13.1 |
| dioxide | tration | | | | | | | |
| content | (ppm) | | | | | | | |
| in | reduc- | 29.0 | 24.0 | 22.0 | 34.0 | 32.0 | 0 | 0 |
| exhaust | tion | | | | | | | |
| | ratio (%) | | | | | | | |
| fuel | con- | 8.3 | 9.3 | 7.3 | 8.5 | 9.4 | 5.0 | 8.0 |
| | sump- | | | | | | | |
| | tion | | | | | | | |
| | rate | | | | | | | |
| | (km/L) | | | | | | | |
| | im- | 66.0 | 60.0 | 26.0 | 47.0 | 62.0 | 0 | 0 |
| | prove- | | | | | | | |
| | ment | | | | | | | |
| | ratio (%) | | | | | | | |

### Example 2 and Comparative Example 2

Table 2 shows the variations of the concentration of nitrogen oxides in the exhaust when the engine was driven to operate as in Example 1 except that hydrogen was supplied to the exhaust purification catalyst converter that were obtained by tests 2-1 through 2-4 and comparison tests 2-1 through 2-4.

Note that the engine was driven to operate under the condition where

the gasoline supply rate was 3.1 L/h

in the tests 2-1, 2-2 and 2-4 and the comparison tests 2-1 through 2-4 and

the gasoline supply rate was 4.2 L/h

in the test 2-3 and the comparison test 2-3. The engine was driven to operate with a degree of accelerator opening of 30% for all the tests.

TABLE 2

| | | | | | | Comp. | Comp. | Comp. | Comp. |
|---|---|---|---|---|---|---|---|---|---|
| | | Test | Test | Test | Test | test | test | test | test |
| | | 2-1 | 2-2 | 2-3 | 2-4 | 2-1 | 2-1 | 2-3 | 2-4 |
| added hydrogen volume % | | 5.0 | 5.0 | 10.0 | 20.0 | 4.5 | 0 | 0 | 0 |
| air-fuel ratio volume ratio | | 22.7 | 22.7 | 19.0 | 22.2 | 22.7 | 22.7 | 19.0 | 22.2 |
| number of revolutions per | | 2500 | 4000 | 4000 | 2500 | 2500 | 4000 | 4000 | 4000 |
| minute (rpm) | | | | | | | | | |
| nitrogen | concentration | 1.8 | 1.5 | 2.7 | 0.7 | 15 | 20 | 650 | 35 |
| oxide | (ppm) | | | | | | | | |
| content in | reduction | 88.0 | 92.0 | 99.0 | 98.0 | 32.0 | 0 | 0 | 0 |
| exhaust | ratio (%) | | | | | | | | |

### INDUSTRIAL APPLICABILITY

According to the present invention, a dehydrogenation reaction of a hydrogen supply mass is realized by means of a dehydrogenation reactor having a catalyst reaction layer formed on a surface thereof and an oxidation catalyst layer formed on the other surface thereof, utilizing the waste heat of the exhaust system of an internal combustion engine. Therefore, the waste heat of the exhaust system can efficiently be utilized to make it possible to efficiently produce hydrogen. Additionally, when the produced hydrogen is used with fuel for the internal combustion engine, it can be combusted stably at a high air-fuel ratio so as to make it possible to improve the fuel consumption and suppress the production of carbon dioxide. Additionally, the concentration of nitrogen oxide that is increasingly produced in a state where the air-fuel ratio is high can be reduced when hydrogen is supplied to the exhaust catalyst converter.

1. A hydrogen supply unit for an internal combustion engine using at least either a hydrogen supply mass or hydrocarbon-based fuel as fuel source, characterized by comprising a dehydrogenation reactor that produces hydrogen from a hydrogen supply mass, the dehydrogenation reactor having on a surface thereof a hydrogen production section carrying a dehydrogenation catalyst and on the other surface thereof an oxidation reaction section carrying an oxidation catalyst for oxidizing the dehydrogenation product produced from the hydrogen supply mass to emit heat, the oxidation reaction section allowing the exhaust from the internal combustion engine to pass therethrough, hydrogen separating means for separating the produced hydrogen and the dehydrogenation product, storage means for storing the separated hydrogen, means for storing the dehydrogenation product and means for supplying and adding the produced hydrogen to the fuel source.

2. The hydrogen supply unit for an internal combustion engine according to claim 1, characterized in that the dehydrogenation catalyst and the oxidation catalyst of the dehydrogenation reactor are borne on the surfaces of porous alumina layers formed after turning the aluminum layers laid on a metal base member into alumite.

3. The hydrogen supply unit for an internal combustion engine according to claim 2, characterized by comprising electrically energizing/heating means for heating the dehydrogenation catalyst by electrically energizing and heating the metal base member itself.

4. The hydrogen supply unit for an internal combustion engine according to claim 1, characterized in that the dehydrogenation reactor is provided with a dehydrogenation product supply nozzle and an air feed pipe for heating a hydrogen reaction section along with a temperature sensor and a hydrogen supply mass injection nozzle.

5. The hydrogen supply unit for an internal combustion engine according to any claim 1, characterized in that an exhaust pipe connected to the dehydrogenation reactor is provided with a branch section that branches the exhaust pipe and the branch section is provided with an exhaust flow rate regulation valve that regulates the flow rate of exhaust according to the temperature of hydrogen production means.

6. The hydrogen supply unit for an internal combustion engine according to claim 1, characterized by comprising hydrogen supply means for supplying the produced hydrogen to an exhaust purification catalyst converter.

7. A method of operating an internal combustion engine using at least either a hydrogen supply mass or hydrocarbon-based fuel as fuel source and comprising a dehydrogenation reactor for producing hydrogen from a hydrogen supply mass, the dehydrogenation reactor having on a surface thereof a hydrogen production section carrying a dehydrogenation catalyst and on the other surface thereof an oxidation reaction section carrying an oxidation catalyst for oxidizing the dehydrogenation product produced from the hydrogen supply mass to emit heat, the oxidation reaction section allowing the exhaust from the internal combustion engine to pass therethrough, hydrogen separating means for separating the produced hydrogen and the dehydrogenation product, storage means for storing the separated hydrogen, means for storing the dehydrogenation product and means for supplying and adding the produced hydrogen to the fuel source, characterized by comprising measuring the concentration of the carbon dioxide discharged from an exhaust pipe of the internal combustion engine and controlling the mixing ratio of hydrogen relative to hydrocarbon fuel so as to make the measured value of the concentration of carbon dioxide not greater than a predetermined value.

8. The method of operating an internal combustion engine according to claim 7, characterized in that the dehydrogenation catalyst is heated by electrically energizing and heating a member of the dehydrogenation reactor.

9. The method of operating an internal combustion engine according to claim 7, characterized in that a dehydrogenation reaction is realized by combusting the dehydrogenation product from a dehydrogenation product supply nozzle with air supplied from an air feed pipe to heat a hydrogen reaction section of the dehydrogenation reactor to a predetermined temperature when the temperature of the hydrogen reaction section is lower than the predetermined value, and subsequently injecting a hydrogen supply mass from a hydrogen supply mass injection nozzle.

10. The method of operating an internal combustion engine according to claim 7, characterized in that the concentration of discharged nitrogen oxide is regulated by supplying part of the hydrogen produced from the hydrogen supply mass to an exhaust purification catalyst converter.
